(19) United States
(12) Patent Application Publication
(10) Pub. No.: US 2015/0310008 A1
(43) Pub. Date: Oct. 29, 2015

(54) CLUSTERING AND SYNCHRONIZING MULTIMEDIA CONTENTS

(71) Applicant: THOMASON LICENSING, Issy-les-Moulineaux (FR)

(72) Inventors: Franck THUDOR, Rennes (FR); Pierre HELLIER, Thorigne Fouillard (FR); Alexey OZEROV, Rennes (FR); Ashish BAGRI, Kolkata (IN)

(21) Appl. No.: 14/648,705

(22) PCT Filed: Oct. 30, 2013
(86) PCT No.: PCT/EP2013/072697

§ 371 Date: May 30, 2015

(30) Foreign Application Priority Data
Nov. 30, 2012 (EP) 12306488.3

(51) Int. Cl. G06F 17/30

(52) U.S. Cl. CPC G06F 17/30026; G06F 17/30575; G06F 17/30598

(57) ABSTRACT

A method and a device for clustering sequences of multimedia contents with regard to a certain event are recommended wherein mel-frequency cepstrum coefficients of the sequences audio tracks of the multimedia contents are used for clustering and synchronizing multimedia contents with regard to a certain event by computing salient mel-frequency cepstrum coefficients from mel-frequency cepstrum coefficient features and clustering sequences having an overlapping audio segment by comparing the salient mel-frequency cepstrum coefficients. Method and device provide an improvement in comparison to fingerprint detection.

### TECHNICAL FIELD

The invention relates to a method and a device for clustering and synchronizing sequences of multimedia contents with regard to a certain event as e.g. independently recorded multimedia contents of a certain event. A further aspect is related to clustering sequences of multimedia content belonging to a certain event in a data base and that said clustering and synchronizing of multimedia content relies on audio similarity of multimedia content as audio or audiovisual content.

### BACKGROUND

The popularity of portable devices, e.g. smartphones, leads to creation of a huge amount of audio-visual recordings of the same or different multimedia presentation events. For example, a concert of a popular music band can be filmed by hundreds of fans, and then all these recordings being uploaded to YouTube. Such collections could be for example efficiently exploited to enhance the corresponding audio-visual content, to create summaries of a particular event, etc. However, to do so, one first needs to identify the videos corresponding to the same event and to synchronize them in time. Doing this relying on the only video sequence seems to be challenging due to high variation of point of views and to the fact that two devices often film completely different parts of a visual scene. However, the task seems becoming easier if one relies on the audio tracks alone. Indeed, whatever the location and orientation of two devices in the same place, they record more or less the same sounds.

Bryan et al. addresses in “Clustering and synchronizing multi-camera video via landmark cross-correlation,” in IEEE International Conference on Acoustics, Speech, and Signal Processing ICASSP, Kyoto, Japan, 03/2012 2012, IEEE, the problem of joint clustering and synchronization of audiovisual contents by audio tracks, that is, regrouping audiovisual contents by event and register them temporally. This is done by using audio fingerprinting, to match the audiovisual contents corresponding to the same event, and to temporally register the matched audiovisual contents. However, it has been found that audio fingerprints may wrongly identify two corresponding recordings at different locations to a similar event as belonging to the same event.

### SUMMARY OF THE INVENTION

It is an aspect of the present invention to provide an improved differentiation regarding whether sequences of multimedia contents correspond to the same event or not, wherein multimedia content means audio or audiovisual content.

Although it is the task of Mel Frequency Cepstrum Coefficients—in the following also denoted as MFCC—to represent the information of an audio signal as efficient as possible, that means in a decorrelated manner, it is nevertheless recommended using MFCC for clustering and synchronizing multimedia contents. It is furthermore recommended to determine salient features from said MFCC by computing dimension-wise maxima of the MFCCs and to compare salient MFCC features of at least two audio tracks of multimedia content for a voting based clustering and a rough synchronization of the audio tracks. Finally, after clustering has been established, a precise synchronization is performed by a precise realignment within each created cluster performed on MFCC features using MFCC cross-correlations computed over a window corresponding to a salient MFCC computation window. In case of audiovisual multimedia content, a pair wise comparison between all videos belonging to the same cluster is performed to find a precise alignment between them. Using the clusters created in the previous step, a pair wise comparison is done between videos belonging to the same cluster to find the precise time offset between them. Each video in a cluster is only compared to all the other videos in the same cluster as the non-overlapping videos have already been separated before as a new cluster is formed if a video does not match with any existing representative cluster or if there is a match but the video has a non-overlapping region. A cluster representative is a minimal set of recording the union of which covers the entire cluster time line. The comparison of two videos is then done in the salient MFCC domain and is based on cross correlation. A complete match-list with time offset between the matching videos is generated. The match-list is used to categorize the videos into events. In such a way, videos which have an overlapping region form a part of the same event. Videos which are not overlapping but are connected to each other via a common video sequence also form a part of the same event, so that all videos belonging to the same event will be clustered and videos belonging to a different event being excluded.

That means, it is proposed a method for clustering and synchronizing multimedia contents with regard to a certain event wherein mel-frequency cepstrum coefficients of audio tracks of the multimedia contents are used for clustering and synchronizing multimedia contents by computing salient mel-frequency cepstrum coefficients as dimension-wise maxima over a predetermined window from the mel-frequency cepstrum coefficients, creating clusters such that every pair of segments having an overlapping audio segment belong to a same cluster by comparing the salient mel-frequency cepstrum coefficient features with regard to that a majority of features correspond to a maximum correlation, creating cluster representatives by matching the longest sequences with others to form intermediate clusters in the salient mel-frequency cepstrum coefficient domain and a fine synchronization by a pair wise comparison between all sequences belonging to the same intermediate cluster to provide a complete match-list with time offset between the matching sequences and categorizing sequences into events for final clustering.

The method for clustering and synchronizing multimedia contents with regard to a certain event is performed in a device comprising extracting means for extracting mel-frequency cepstrum coefficients from audio tracks of the multimedia contents, computing means for calculating dimension-wise maxima over a predetermined window from the mel-frequency cepstrum coefficients to provide salient mel-frequency cepstrum coefficients, comparing means for comparing the features of the salient mel-frequency cepstrum coefficients with regard to that a majority of features correspond to a maximum correlation for creating clusters such that every pair of segments having an overlapping audio segment belong to a same cluster, voting means for providing cluster representatives by matching the longest sequences with others to form intermediate clusters in the salient mel-frequency cepstrum coefficient domain, synchronizing means for a pair wise comparison between all sequences belonging to the same intermediate cluster to provide a complete match-list with time offset between the matching sequences and sorting means for categorizing sequences into events for final clustering. That means that the invention is characterized in that mel-frequency cepstrum coefficients of audio tracks are used for clustering multimedia contents with regard to a certain event by determining salient mel-frequency cepstrum coefficient values from mel-frequency cepstrum coefficient vectors and clustering segments having an overlapping audio segment by comparing the salient mel-frequency cepstrum coefficient values. Synchronization is performed by comparing sequences of the same cluster with regard to a time offset, and a final clustering comprises categorizing sequences into events as sequences which have an overlapping segment form a part of the same event and sequences which do not overlap but are connected via a common sequence also form part of the same event.

The problem of clustering and synchronizing multimedia contents with regard to a certain event is solved by a method and a device as a processor-controlled machine disclosed in the independent claims. Advantageous embodiments of the invention are disclosed in respective dependent claims.

It has been found out that audio fingerprints may be too robust for the task of identification of the same event and as they are resistant against additive noise. This property makes them too robust to be able to distinguish the same music played at different events. In such a way, two audio sequences, being the same song but played at two different parties, could be wrongly clustered together. Audio fingerprints are robust to ambient sounds and would most probably wrongly identify the two corresponding recordings as belonging to the same event.

In contrast, MFCCs, while not robust to additive perturbations, capture also information about ambient sounds. MFCCs, as compared to fingerprints, allow better differentiation between the same songs played by the same group in different concerts.

Preferably, according to the invention, the comparing is a result of a voting approach function of the determined MFCC features which only needs fixing on one non-adaptive threshold to avoid other heuristics to filter out the high number of false positives by adaptive threshold values. It is an advantage of the recommended method and device that one non-adaptive threshold is sufficient and cluster representatives are used to address a large scale issue with regard to the size of the dataset. To address large scale issue, joint clustering and alignment in a bottom-up hierarchical manner are performed by splitting the database in subsets at the lower stages and by comparing only clustering representatives at the higher stages. Such a strategy, applied in several stages, reduces the computational complexity, thus allows addressing much bigger datasets. Favorably, a created cluster contains one or more cluster representative and comprising the adding of a new audiovisual segment to the created cluster if a new audiovisual segment matches the one or more representatives.

According to another aspect of the invention, a positive comparing leads to the determination of a time offset between two audiovisual segments of a pair of segments. Preferably, the audiovisual segments of a created cluster are temporally aligned by using the determined offset. For a better understanding, the invention shall now be explained in more detail in the following description with reference to the figures. It is understood that the invention is not limited to the described embodiments and that specified features can also expediently be combined and/or modified without departing from the scope of the present invention as defined in the appended claims.

### BRIEF DESCRIPTION OF THE DRAWINGS

The accompanying drawings, which are included to provide a further understanding of the invention, and are incorporated in and constitute a part of this specification, illustrate embodiments of the invention and together with the description serve to explain the principles of the invention.

In the drawings:

FIG. 1 shows users equipped with a smartphone comprising audiovisual capturing means during a concert;

FIG. 2 is a schematic illustrating the structure of the invention;

FIG. 3 is a schematic illustrating examples of cluster representatives;

FIG. 4 shows in a diagram a standard deviation of video length per cluster according to the average video length per cluster for a dataset of concert videos cluster;

FIG. 5 illustrates in a diagram the accuracy of the method according to the invention; and

FIG. 6 illustrates in a diagram the clustering performance of the inventive method with regard to split configurations.

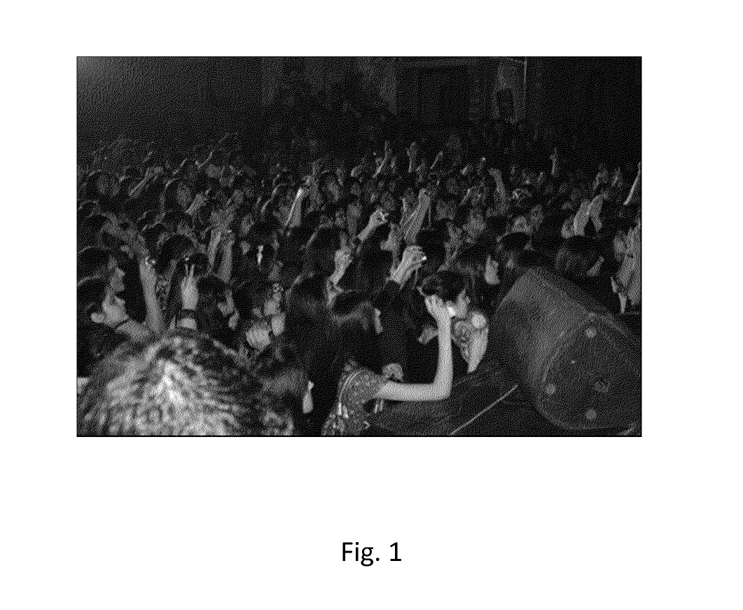

### DETAILED DESCRIPTION OF PREFERRED EMBODIMENTS

Reference will now be made in detail to the preferred embodiments of the present invention, examples of which are illustrated in the accompanying drawings. With reference to the accompanying drawings, the present invention will now be described in detail. In the description and drawings of the present invention, the same reference characters are given to the same elements.

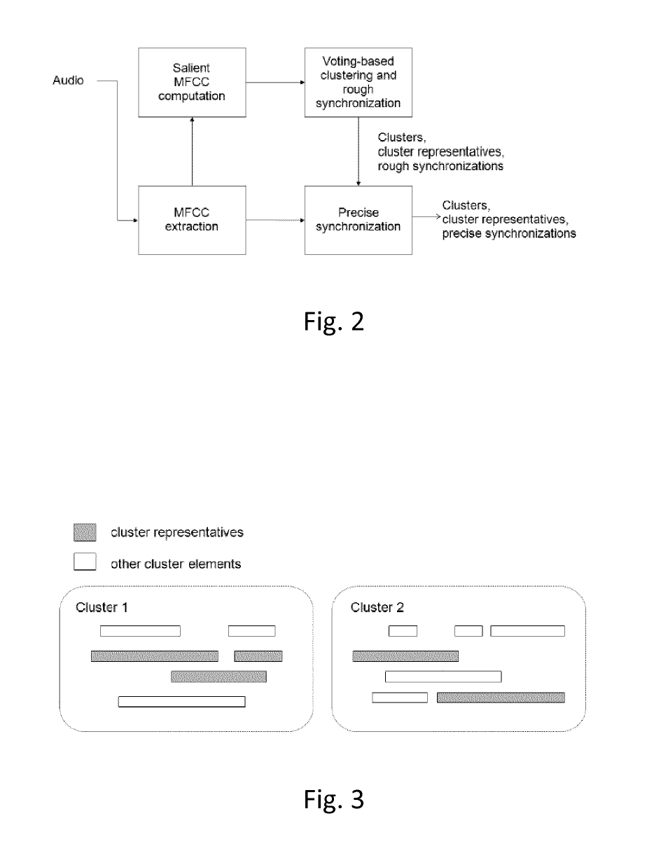

FIG. 2 is a schematic illustrating the structure with regard to the method and a device of the present invention as mel-frequency cepstral coefficients MFCCs are first extracted for each of the multimedia content as audio recording Audio. Cepstral coefficients obtained for mel-ceptrum are referred to as Mel-Frequency Cepstral Coefficients often and here also denoted by MFCC. MFCC is a representation of the audio signal Audio. Audio samples within a window W are combined through discrete Fourier transformation and discrete cosine transformation on a mel-scale to create one MFCC sample as a multi-dimensional vector d of floating values. To reduce the number of features describing an audio sequence and hence limit the complexity, salient mel-frequency cepstrum coefficients Salient MFCC are computed from the original MFCC vectors as illustrated in FIG. 2. Only maximal MFCC values over a sliding window W are retained for each dimension of a MFCC independently. This selection of salient mel-frequency cepstrum coefficients Salient MFCC is based on the notion that the maximum value is likely to be retained in other audio of the same content even under influence of noise. A salient mel-frequency cepstrum coefficient Salient MFCC is a representation that has only a fraction of about 10% of the components of the original MFCC features and is still sufficient robust to be able to compare two audio files. It also provides a way to perform the comparison at a coarse level to filter obvious none matching and reduces the number of matching performed at the granular level. A two stage approach has been used but it can be envisioned to perform the comparisons at several different levels. Clustering sequences having an overlapping audio segment with regard to a certain event is performed by comparing the salient mel-frequency cepstrum coefficients Salient MFCC by applying a voting approach function Voting-based clustering to the mel-frequency cepstrum coefficient features as a comparison with regard to whether a majority of features corresponds to a maximum correlation for a rough synchronization. As illustrated in FIG. 2, said clustering provides already a rough synchronization with regard to a certain event as none matching sequences already have been excluded and cluster representatives can be generated by matching the longest sequences with others to form intermediate clusters in a salient mel-frequency cepstrum coefficient domain. That means that for clustering multimedia contents with regard to a certain event mel-frequency cepstrum coefficients MFCC of audio tracks of the multimedia contents are used for clustering and synchronizing or aligning multimedia contents with regard to a certain event, as mel-frequency cepstrum coefficients MFCC in addition capture information about ambient sound which in comparison to fingerprints makes it possible to distinguish more precise between different events. Cluster representatives are advantageous with regard to forming clusters as newly processed recordings are compared—aligned and matched—to these representatives as it is imaginable by the illustration shown in FIG. 3, that cluster representatives drastically limit the required number of comparisons for clustering. Finally a fine synchronization and final clustering are recommended. That means that the method further comprises a synchronization by comparing sequences of the same cluster with regard to a time offset and further comprises a final clustering by categorizing sequences into events as sequences which have an overlapping segment form a part of the same event and sequences which do not overlap but are connected via a common sequence also form part of the same event.

That means for a concrete embodiment that for a given set of audio Audio or audiovisual files, MFCC features are first extracted for all recordings of the audio Audio or audiovisual files also named as AV files.

Then, salient MFCC features as salient mel-frequency cepstrum coefficients Salient MFCC, that are dimension-wise maxima of MFCCs over some window, are computed. Joint clustering and synchronization is then performed on salient MFCCs using. This is done in two substeps:

In the first substep, cluster representatives recordings are compared sequentially—starting from the longest ones—while creating clusters with their representatives and newly processed recordings are only compared—that is temporally registered and matched—to these representatives.

In a second substep, voting is applied: while comparing two recordings, the cross-correlation of the two recordings is computed independently for each salient MFCC dimension, and the matching is established if and only if the cross correlation maximum location is the same for a sufficient pre-defined number of dimensions.

Finally, once a clustering has been established, a precise realignment within each created cluster is performed on MFCCs features using MFCC cross-correlations computed over a reduced window or a window corresponding to salient MFCC computation window.

The proposed approach for joint clustering and synchronization is more robust to presence of similar predominant audio content as e.g., the same music played in different parties, since it relies on MFCCs that, in contrast to audio fingerprints, describe the overall audio content, scales with dataset size and average recordings size thanks to the use of cluster representatives and salient MFCCs, it is easier to implement and reproduce thanks to the proposed voting approach for matching decision that allows avoiding adaptive thresholds and heuristic post-filtering.

There are few steps that can be done off-line before the clustering and temporal registration process start.

In the following example, the window W has a width of 40 ms with an overlap of 50% and the multi-dimensional vector d to be 12.

To reduce the number of features describing an audio and hence limit the complexity, salient MFCC values from the original MFCC vectors are extracted. It is a representation that has only a fraction of about 10% of the components of the original MFCC features and is still robust enough to be able to compare two audio files. To compute the salient MFCC, only the maximal MFCC values are retained over a sliding window of Ws. This is done over each of the d dimension of MFCC independently.

This selection of salient MFCC is based on the notion that the maximum value is likely to be retained in other audio of the same content even under influence of noise. This framework also provides us a way to perform the comparison at a coarse level to filter our obvious none matching and reduces the number of matching performed at the granular level. In the present approach, a two stage approach but it can be envisioned to perform the comparisons at several different levels.

A first level clustering is performed to group the set of videos which have a common overlapping segment. Since a goal is to work with large datasets, it quickly becomes infeasible to compare all videos with each other. To avoid comparing each video with every other video in the database, clusters are created and each cluster has a cluster representative. Cluster representatives are videos which have an overlapping segment with all the other videos in that cluster. To form clusters, the videos are arranged based on their lengths, starting with the longest video first. The longest video is made a cluster representative of the first cluster. At every stage of this clustering process, videos are only compared to the existing cluster representatives.

If a video has an overlapping segment with an existing cluster representative, that video is added to that cluster.

A new cluster is formed if a video does not match with any existing representative or if there is a match but the video also has a non-overlapping region. The comparison of two videos is done on the salient MFCC domain and is based on cross correlation, description of which is detailed further. The clustering technique of not comparing all videos with each other and the fact that the comparison is done on a sparse salient MFCC's provides an effective mechanism to deal with very large datasets without increasing the computation time exponentially.

The temporal registration and matching of videos as well as the final clustering will now be described.

A pair wise comparison is done between all the videos belonging to the same cluster to find precise alignment between them. Using the clusters created in previous step, a pair wise comparison is done between videos belonging to the same cluster to find the precise time offset between them. Each video in a cluster is only compared to all the other videos in the same cluster as the non-overlapping videos have already been separated as described before. A complete match-list with time offset in seconds between the matching videos is generated. Using this match-list, videos are categorized into events. Videos which have an overlapping region form part of the same event. Videos which are not overlapping but are connected to each other via a common video also form part of the same event.

The actual comparison between any two videos is carried by computing the cross correlation on the feature values. In the clustering step, the features used are the salient MFCC values while in the temporal registration of matching videos and final clustering, the features used are complete MFCC values. Cross correlation is an effective way to find the time offset between two signals which are shifted versions of each other.

To find the offset, a novel voting approach. Since MFCC consists of multi-dimensional vector d with several dimensions which are decorrelated during the creation of the features, the cross correlation is performed on each of the dimension separately. The peak in each of the dimension points to a time offset between the two compared signals. If the two signals really do match, then the time offset in most of the dimension points to the same correct value. If the signals do not match, the cross correlation in each dimension has a peak at different offsets and hence we can easily detect that there is no match between these signals. A voting approach is used where each dimension votes for its selected time offset and if the majority of the dimensions point to the same window of time offset, a match is declared between the two signals with the given time offset.

In the context of this application, new additional videos can be added on a database/system where the temporal registrations have already been computed. To add these additional videos, the new videos needn't be compared to all the existing videos in the database. In the adopted approach, for each intermediate cluster computed, a cluster center is identified. It is generally the longest video which has the largest overlapping region with all the other videos in that cluster. This cluster center is identified and stored for further use. For every new video that is being added, instead of comparing it with all the existing videos to find if they have an overlap, it is enough to just match it with the existing cluster centers. This way the proposed framework handles incremental data while still using the advantages that it provides in the first place. The intermediate clusters provide a starting point for new videos to be added. Once the events of the new videos have been identified, it is then matched to the existing videos of that event to create a precise temporal registration. This has the advantage to make the system more scalable. The proposed framework can handle large amounts of data without exponentially increasing the computations. The comparison carried out on salient MFCC features makes the comparison quick and robust while the intermediate clusters provides a mechanism to reduce the number of comparisons to a bare minimum required.

In the following, some experimental results are shown.

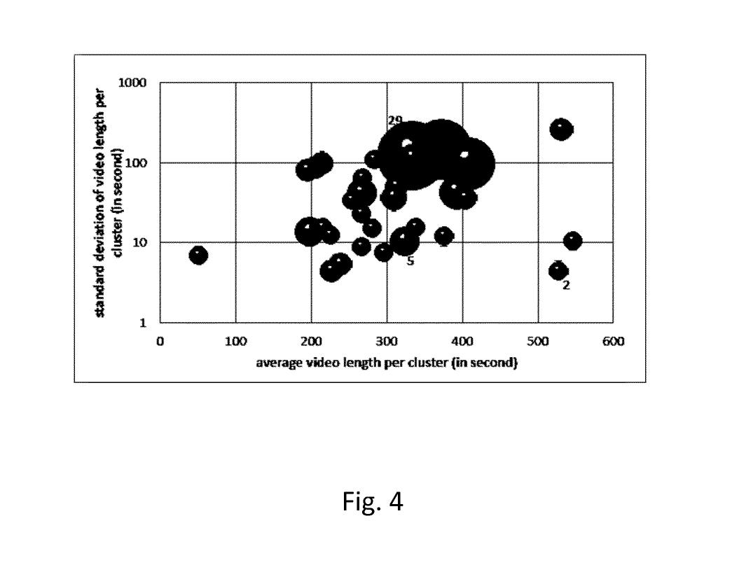

The dataset consists of user contributed videos taken from YouTube. A total of 164 videos from 6 separate artist and bands having a cumulative duration of 17.56 hours were used. The longest sequence was of 21 minutes while the shortest one was of 44 seconds. A hand man groundtruth of 36 clusters was realized on this dataset. From this groundtruth, a binary matrix of size 164*164 is generated, where ones and zeros code respectively for matching and non-matching sequences. This matrix is denoted GT matching. The details of the dataset can be seen in FIG. 4, in which each cluster of videos is represented by a bubble whose width is proportional to the number of videos inside the cluster whose coordinates are given by the average video length per cluster in seconds and the standard deviation of video length per cluster in seconds.

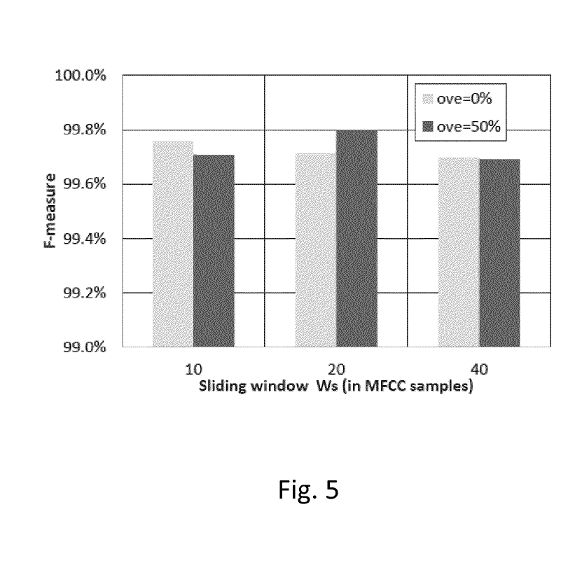

Salient MFCC representation is first evaluated on the entire dataset, through the exhaustive 164*163/2=13366 comparisons which are compared to the GT matching matrix. It is used an F-measure criteria to summarize precision P and recall R as F=2PR=(P+R). F-measure results are plotted in FIG. 5 with different sets of parameters. The parameters are the sliding window Ws equal to 10, 20 or 40 MFCC samples and an overlap ove between consecutive windows of 0% and 50%.

These results show that the proposed method is really robust for comparing the videos with a light representation.

They also show that the salient representation is not so much sensitive to parameterization. The configuration Ws=20 and ove=50% was elected.

In a second step, the clusters results obtained with the temporal registration and final clustering method are compared. With the 36 clusters of the groundtruth, all but one are found correctly. The missed one is a two song cluster—Muse-Unintended—which is badly merged with a five-song cluster—Muse-Feeling Good—captured during the same event. The two songs are correctly synchronized together, but the analysis of the *.wav files showed that one of them exhibit a very low signal to noise ratio SNR, leading to a mismatch with one of the representative of the other cluster. Such cases could be alleviated by filtering the sequences before creating the dataset.

But for each individual cluster a manual check has been performed a-posteriori by loading the cluster's elements on audacity and listening to them. Using a human ear, all the sequences are correctly synchronized.

Regarding the complexity analysis, cross correlation between two signals for every possible shifts is O (N Log N) when FFT based cross correlation is used. To create the matchlist for K=164 sequences, normally the number of cross correlations needed would be 13366 (164*163/2), leading to a complexity Cbaseline:

C_{baseline}=K*(K−1)/2*N*log(N)

where N is the average number of MFCCs per sequence.

Using the salient representation allows a reduction in the size of the signals to be compared. Hence, a clustering based on the salient MFCCs would exhibit a complexity Csalient:

Cₛₐₗᵢₑₙₜ=K*(K−1)/2*N_{c}*log(N_{c})

where Ncis the average number of salient MFCCs per sequence.

When N becomes high, this reduction is proportional to the ratio Nc=N of 10% in the current case. But in the adopted approach, not all comparisons need to be made. The complexity formula is separated into two parts. The first one deals with the salient MFCCs and is devoted to the clustering.

The second one deals with MFCCs and is devoted to the fine synchronization around the coarse synchronization given by the salient MFCCs correlation.

Hence, the complexity becomes Cours:

Cₒᵤᵣₛ=Nb_{crude}*N_{c}*log(N_{c})+Nb_{fine}*N*Log(Wₛ)

where Nbcrude and Nbfine are respectively the number of computations performed at salient and fine level according to the present invention. Some values were computed for the dataset and are presented in table 1.

TABLE 1
Comparison of targeted complexity with respect to baseline
(i.e. all cross-correlation at MFCC level) on our dataset.

| | baseline | salient | ours |
|---|---|---|---|
| complexity | 100% | 3.8% | 2.6% |

Only a small fraction of the baseline's computations is needed with the proposed method.

Regarding the scalability, stability tests were carried out to simulate the effectiveness of the adopted approach to incremental additions of video into an existing database. For this purpose, the dataset has been split into two parts. The first part is then clustered and aligned using the recommended approach and the second part is incrementally added to the database. The following configurations were tested:

120+44; 100+64; 90+74; 84+80

For each configuration, many different split were randomly run, leading to a total of 175 tests. The precision, recall and F-measure of the final matchlist have then been calculated, in all of 175 tests, and were compared to the GT matching matrix.

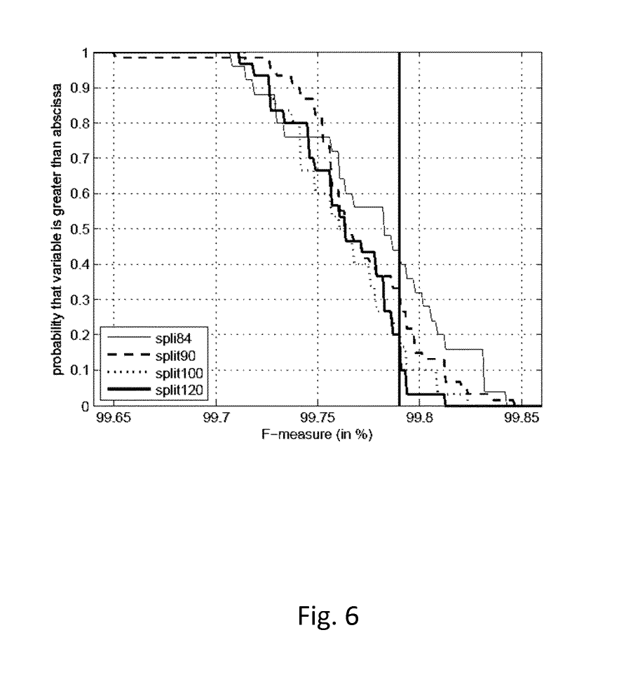

As summarized in table 2 below showing values of mean deviation μ, and standard deviation σ and as also illustrated in FIG. 6, the results showed equivalent performance whatever the configuration.

TABLE 2
Mean and standard deviation of precision, recall
and F-measure when the database is split.

| Configuration | | 164 | 120 + 44 | 100 + 64 | 90 + 74 | 84 + 80 |
|---|---|---|---|---|---|---|
| Precision (%) | μ | 99.99 | 99.95 | 99.93 | 99.92 | 99.92 |
| | σ | — | 0.02 | 0.02 | 0.03 | 0.02 |
| Recall (%) | μ | 99.60 | 9.57 | 99.59 | 99.61 | 99.63 |
| | σ | — | 0.04 | 0.05 | 0.05 | 0.07 |
| F-measure (%) | μ | 99.79 | 99.76 | 99.76 | 99.77 | 99.77 |
| | σ | — | 0.02 | 0.02 | 0.03 | 0.04 |

FIG. 6 illustrates the probability that variable is greater than abscissa over F-measure in percent % when the database is split for the configurations mentioned above.

Tests showed the ability of the invention to incrementally add videos to the database while keeping the same performance without doing extra calculations as compared to adding all the videos together.

The split approach provides a way to make the system scalable and incremental and to be able to effectively split the task when a very large number of videos need to be compared and synchronized.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the claims.

1. Method for clustering sequences of multimedia contents with regard to a certain multimedia presentation event wherein mel-frequency cepstrum coefficients of audio tracks of the multimedia contents are used for clustering and synchronizing multimedia contents with regard to a certain event by
computing salient mel-frequency cepstrum coefficients from mel-frequency cepstrum coefficient features and clustering sequences having an overlapping audio segment by comparing the salient mel-frequency cepstrum coefficients.

2. Method according to claim 1, wherein the mel-frequency cepstrum coefficient features are mel-frequency cepstrum coefficient vectors.

3. Method according to claim 1 further comprising a synchronization by comparing sequences of the same cluster with regard to a time offset.

4. Method according to claim 1 further comprising a final clustering by categorizing sequences into events as sequences which have an overlapping segment form a part of the same event and sequences which do not overlap but are connected via a common sequence also form part of the same event.

5. Method according to claim 1, wherein said salient mel-frequency cepstrum coefficients are computed as dimension-wise maxima over a predetermined window from the mel-frequency cepstrum coefficients.

6. Method according to claim 1, wherein said mel-frequency cepstrum coefficient features are compared with regard to whether a majority of features corresponds to a maximum correlation.

7. Method according to claim 6, wherein the comparing is a result of a voting approach function of the mel-frequency cepstrum coefficient features.

8. Method according to claim 1, wherein cluster representatives are generated by matching the longest sequences with others to form intermediate clusters in a salient mel-frequency cepstrum coefficient domain.

9. Method according to claim 8, wherein a created cluster contains one or more cluster representative and comprises the adding of a new audio or audiovisual segment to the created cluster if a new audio or audiovisual segment matches the one or more representatives.

10. Device configured to cluster sequences of multimedia contents with regard to a certain multimedia presentation event comprising:
extracting means configured to extract mel-frequency cepstrum coefficients from the sequences audio tracks of the multimedia contents,
computing means configured to calculate dimension-wise maxima over a predetermined window from the mel-frequency cepstrum coefficients to provide salient mel-frequency cepstrum coefficients,
comparing means configured to compare the features of the salient mel-frequency cepstrum coefficients with regard to that a majority of features correspond to a maximum correlation for creating clusters such that every pair of segments having an overlapping audio segment belong to the same cluster.

11. Device according to claim 10, comprising voting means configured to determine cluster representatives by matching the longest sequences with others to form intermediate clusters in the salient mel-frequency cepstrum coefficient domain.

12. Device according to claim 10, further comprising:
synchronizing means configured to pair wise compare between all sequences belonging to the same intermediate cluster to provide a complete match-list with time offset between the matching sequences.

13. Device according to claim 10, further comprising: sorting means configured to categorize sequences into events for final clustering.

14. Device according to claim 10 wherein the device configured to clustering sequences of multimedia contents with regard to a certain event is a processor-controlled machine.
